(19) United States
(12) Patent Application Publication
(10) Pub. No.: US 2011/0242554 A1
(43) Pub. Date: Oct. 6, 2011

(54) SYSTEM AND METHOD FOR PROVIDING AN EXTENSIBLE MULTINATIONAL POSTAGE SERVICE AND SYSTEM AND METHOD THAT DELIVERS PRINTABLE POSTAGE TO A CLIENT DEVICE

(75) Inventors: Patrick Farry, Cupertino, CA (US); Richard Hernandez, Half Moon Bay, CA (US); Deanna Foster, Campbell, CA (US)

(73) Assignee: PSI SYSTEMS, Inc.

(21) Appl. No.: 13/139,474

(22) PCT Filed: Dec. 8, 2009
(86) PCT No.: PCT/US2009/067162

§ 371 Date: Jun. 13, 2011

Related U.S. Application Data
(60) Provisional application No. 61/122,213, filed on Dec. 12, 2008.

(51) Int. Cl. G06K 15/02

(52) U.S. Cl. 358/1.6; 358/1.15

(57) ABSTRACT

A system and method for providing an extensible multinational postage service is provided. In particular, the extensible multinational postage service may be based upon a scalable technology infrastructure capable of providing postage services for multiple national post offices and further capable of being integrated with various third-party systems. For example, the system may include, among other things, a web server configured to receive at least one postage request from a client device, wherein the postage request may include a country code that identifies a national post office. A label server coupled to the web server may be configured to assemble a printable postage image based on the specified country code and deliver the printable postage image to the client device.

### FIELD OF THE INVENTION

The invention relates to a system and method for providing an extensible multinational postage service. The invention also relates to an apparatus and method that can deliver printable postage to a client device.

### BACKGROUND OF THE INVENTION

Known online postage systems, such as Endicia™ Internet Postage (www.endicia.com), enable Internet users to purchase United States postage and apply individual postage indicia to a wide spectrum of envelopes and labels using standard computer printers. These systems tend to be based on the concept of Information Based Indicia (“IBI”), wherein information uniquely identifying a particular postage indicium (e.g., postage meter account number and meter piece count) is presented in a barcode and/or human readable form on each mailpiece. Existing online postage systems have historically focused on producing complete mail pieces, envelopes, or labels that may contain, among other things, a destination address, return address, postage indicium, date of mailing, class of mail, optional graphics and branding, and mail processing barcodes (e.g., POSTNET™ or Delivery Confirmation™).

The industry of electronic commerce (or “e-commerce”) has greatly contributed to growth in the popularity of online postage services, which provide an efficient and cost-effective way to support a high volume of transactions that e-commerce companies typically deal with. For example, Endicia™ Internet Postage enables e-commerce sellers to purchase and print a virtually unlimited number of postage and shipping labels upon immediate request, which allows sellers to rapidly fulfill product orders, even at high volume, without expensive postage metering hardware. However, current online postage systems tend to require sellers to manage multiple applications, including different applications for handling payment, postage, and shipping, which can create inefficiencies in operation of a business. Furthermore, existing online postage systems tend to provide technology infrastructures that can only support a single national post office, but sellers often have to ship mail pieces to different countries that may have different postage generation requirements (e.g., different postage rates, security requirements, etc.).

As such, purchasing postage over the Internet has been increasingly popular among volume sellers and ordinary citizens alike as a way of obtaining postage without having to make a trip to the local post office or postage retailer. Using these systems, any customer can use an online postage system to print postage from the comfort of their home or office. For example, any user with a computer and a network connection can simply access the online postage system to purchase postage. Upon receiving payment from the user, the online postage service provider may then send postage data back to the user to allow the postage to be printed using any suitable printer that may be connected to the computer (e.g., an inkjet or laser printer).

However, postage affixed to a mail piece must typically conform with many security and authenticity specifications of the relevant national post office before being deliverable via the national post office. For instance, the United States Postal Service requires that certain codes, marks, or other indicia be printed on a postage label in a predetermined configuration. Therefore, the manner in which online postage is provided to a printer can be critical, as misprinted postage indicia may cost users time, money, or other hassles associated with requesting reimbursement and submitting proof of the misprint. Furthermore, as discussed above, different national post offices typically have different security and authenticity requirements, yet existing online postage systems do not adequately utilize a common back-end technology infrastructure to concurrently support multiple countries in one system.

Moreover, because of the need to ensure that online postage does not misprint or otherwise fail at the user's system, an important concern in online postage systems involves providing a secure mechanism for enabling users to test the online postage prior to printing. However, enabling test prints for online postage can be subject to potential theft or fraud, as users could conceivably print the postage multiple times. For example, traditional techniques used in online postage systems, such as Swiss Poste (www.postmail.ch) and Deutsche Post (www.internetmarke.de), include generating a document using Portable Document Format (PDF) or another format and making the document available for the user to print using a native application associated with the document format (e.g., Adobe Acrobat). Users would then be able to print the postage multiple times or save the postage for later reprinting, thus reusing duplicated postage and committing fraud with ease. Thus, existing systems do not adequately provide a secure and theft-proof mechanism for removing a user's ability to view, save, and reprint postage, while still allowing the user to perform a test print for the postage.

Existing systems suffer from these and other problems.

### SUMMARY OF THE INVENTION

According to one aspect of the invention, a system for providing an extensible multinational postage service may support postage requests for a plurality of national post offices. In one implementation, the system may comprise, among other things, a web server that includes one or more processors configured to receive at least one postage request from a user, wherein the postage request includes a country code that identifies a national post office. A label server coupled to the web server may further include one or more processors configured to create a unique postage indicia based on the country code specified in the postage request. The label server may then communicate with an image server to assemble a printable postage image for the postage request, and the printable postage image may then be delivered to the user. Further, the label server may provide an exposed application program interface that can be used to integrate one or more third-party applications with the system, wherein the integrated third-party applications can communicate with the label server using web service calls issued via the exposed application program interface. In one implementation, the system may also comprise one or more databases that store information relating to the plurality of national post offices, wherein the system can be extended to support new national post offices by adding one or more data fields for the new national post offices.

According to one aspect of the invention, a method for providing an extensible multinational postage service may support postage requests for a plurality of national post offices. In one implementation, the method may comprise, among other things, receiving at least one postage request from a user, wherein the postage request includes a country code that identifies a national post office. A unique postage indicia may be created based on the country code specified in the postage request, wherein a printable postage image may be assembled for the postage request and subsequently delivered to the user. Further, an exposed application program interface may be used to integrate one or more third-party applications with the extensible postage service, wherein the integrated third-party applications can communicate with the extensible postage service using web service calls issued via the exposed application program interface. In one implementation, information relating to the plurality of national post offices may be stored in one or more databases, wherein the extensible postage service may be extended to new national post offices by adding one or more data fields for the new national post offices.

According to one aspect of the invention, a system for silently delivering printable postage to a user may comprise at least one processing device configured to receive at least one postage request from a client device associated with a user. A printable postage image may be assembled for the postage request, wherein the printable postage image includes a unique postage indicia associated with a national post office. The printable postage image may then be delivered to the client device, wherein the client device is configured to execute a script that automatically delivers, the printable postage image to a printer attached to the client device without displaying the printable postage image to the user. For example, in one implementation, the printable postage image may be formatted as a Portable Document Format (PDF) document, and the script comprises a jPDFPrint silent printing application.

According to one aspect of the invention, a method for silently delivering printable postage to a user may comprise receiving at least one postage request from a client device associated with a user. A printable postage image may be assembled for the postage request, wherein the printable postage image includes a unique postage indicia associated with a national post office. The printable postage image may then be delivered to the client device, wherein the client device is configured to execute a script that automatically delivers the printable postage image to a printer attached to the client device without displaying the printable postage image to the user. For example, in one implementation, the printable postage image may be formatted as a Portable Document Format (PDF) document, and the script comprises a jPDFPrint silent printing application.

Other objects and advantages of the invention will be apparent to those skilled in the art based on the following drawings and detailed description.

### BRIEF DESCRIPTION OF THE DRAWINGS

FIG. 1A illustrates a block diagram of an exemplary system for providing postage generation services, which can be extended for multiple national post offices and integrated with various third-party systems, according to one embodiment of the invention.

FIG. 1B illustrates a flow diagram of an exemplary process workflow in the postage service system illustrated in FIG. 1A, according to another embodiment of the invention.

FIG. 2 illustrates a flow diagram of an exemplary process for silently delivering printable postage to a user, according to another embodiment of the invention.

FIG. 3 illustrates a block diagram of a system and workflow for silently printing postage at a user system according to the process illustrated in FIG. 2, according to another embodiment of the invention.

### DETAILED DESCRIPTION

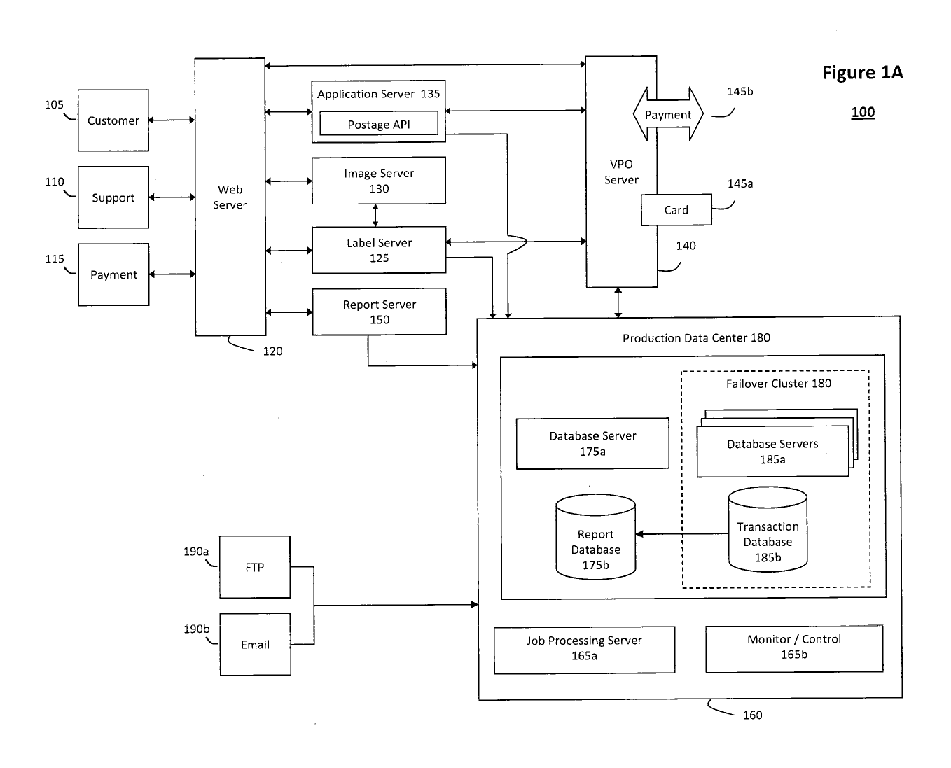

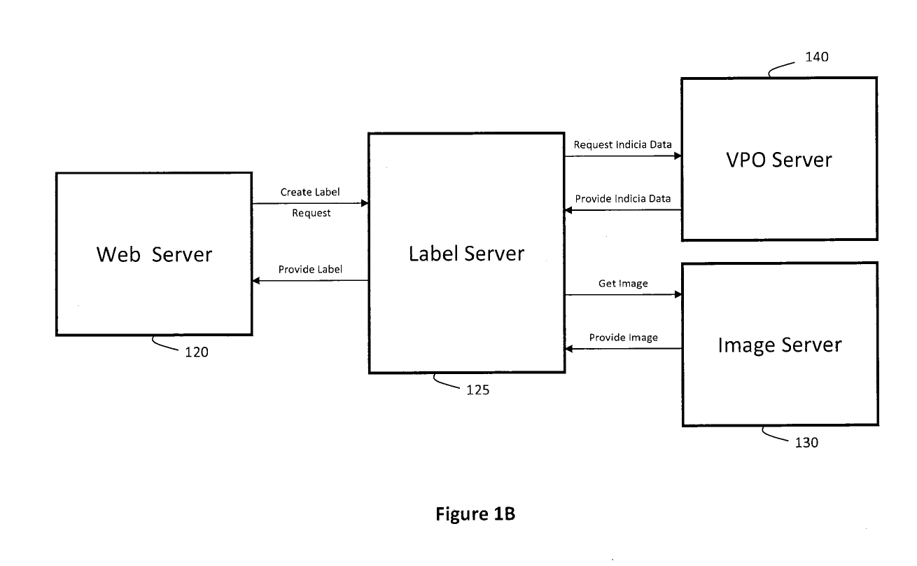

According to one aspect of the invention, FIG. 1A illustrates an exemplary system 100 for providing postage generation services, which can be extended for multiple national post offices and integrated with various third-party systems. In particular, the system 100 illustrated in FIG. 1A may provide an extensible technology platform that can be used to print postage for multiple national post offices that may have different security requirements and postage generation requirements. Thus, the system 100 illustrated in FIG. 1A may provide an efficient mechanism for deploying Internet-based postage printing services to multiple countries, while further including a web services interface that permits licensed and approved third-party developers to integrate postage shipping applications or other solutions for any given country without requiring any software to be installed on a user machine.

As shown in FIG. 1A, the system 100 may include a plurality of components, including a web server 120 that includes one or more processors, a label server 125 that includes one or more processors, an image server 130 that includes one or more processors, an application server 135 that includes one or more processors, a virtual post office server 140 that includes one or more processors, a report server 150 that includes one or more processors, and a production data center 160 that includes one or more processors, among other things. In one implementation, the system 100 may be certified as cryptographically secure pursuant to the Federal Information Processing Standard (FIPS) 140 while utilizing a Service Oriented Architecture (SOA) to handle web service calls among the plurality of components. The SOA may be used to divide the plurality of components into independent modules, each of which perform a given service while cooperating with other components to deliver overall functionality of the system 100. For example, different applications used in the system 100 may be associated with different workflows and label requirements, and in one implementation, a distinct application server 135 may be configured to manage each particular application. The SOA may allow the workflows to be removed from individual components of the system 100, and to instead provide the workflows to another coordinating entity (e.g., the web server 120), which may coordinate the workflows between the various components of the system 100 in a manner specific to each particular application.

As used herein, a service may be defined as a unit of work to be performed on behalf of a particular computing entity (e.g., another component of the system 100, a human user, or another computing entity). The SOA may define how two components of the system 100 interact in order for one of the components to perform a service on behalf of the other. Each interaction between components may be self-contained and loosely coupled, whereby each interaction between two of the components can be considered independent of any other interaction between components.

In one implementation, the interaction between among the components of the system 100 may be based on Simple Object Access Protocol (SOAP) web service calls. The system 100 may also employ a stateless transaction processing model in connection with the web service calls, which may allow for horizontal scaling of the system 100 (e.g., several physical servers may be used to provide a given service). The scalability of the system 100 may allow redundant hardware to be provisioned at various points of the architecture, whereby full operation of the system 100 can be preserved even if one or more hardware components fail. Furthermore, because the system 100 may be built around standard web service calls, many standard products and technologies in existence can be seamlessly integrated into the system 100 without custom development. It will be appreciated, however, that other communication mechanisms may be used, including a postage application program interface that handles communication between applications hosted on the application server 135 and the virtual post office server 140.

Referring to FIG. 1A, primary users of the system 100 may include customers 105 purchasing online postage and support staff 110 providing support for the customers 105. The customers 105 and support staff 110 may connect to a web server 120 using standard web browsers, and the web server 120 may be further connected to one or more external systems that deliver information to the system 100, such a payment system 115 (e.g., a Scellius payment system). In one implementation, incoming traffic received at the web server 120 may be based on HyperText Transfer Protocol (http), HyperText Transfer Protocol over Secure Socket Layer (https), or another suitable protocol, as will be apparent. As such, in one implementation, personal or sensitive information received at the web server 120 may be encrypted using the Secure Socket Layer (SSL) protocol. In one implementation, the web server 120 may include several physical web servers combined with a load balancing mechanism to provide redundancy and high transactional throughput, among other things. The physical web servers may be hosted in a secure zone known as a demilitarized (or demarcation) zone (DMZ), wherein the DMZ may use one or more firewalls that partition the physical web servers from other components of the system 100 and from public networks.

The web server 120 may further one or more web pages configured to enable the customer 105 to electronically purchase valid postage. For example, the one or more web pages may provide front-end interfaces through which the customer 105 and support staff 110 can access postage and label services associated with one or more other components in the system 100, as will be described in more detail below. In one implementation, the web server 120 and/or the web pages accessible therein may be built using Adobe™ ColdFusion® (i.e., a web server and Java-based development environment for complex web applications), which may be hosted on a Microsoft™ Internet Information Server (IIS). Furthermore, aspects of the web server 120 configured to handle secure communications with external systems, including the payment system 115, may be based on Microsoft™ ASP.NET, which provides a web application framework that can be used to provide dynamic web services and applications.

In one implementation, the web server 120 may be coupled to the label server 125, which may be configured to create and format sheets of postage stamps and envelopes, among other things. The label server 125 may operate in a load balanced cluster of physical servers, providing redundancy for fault tolerance and scalable performance. In response to the system 100 receiving and processing an order from the customer 105, the web server 120 may create a label request and communicate the request to the label server 125 (e.g., as illustrated in FIG. 1B). The label server 125 may then assemble a print ready format of the order. For example, as illustrated in FIG. 1B, the label server 125 may communicate with the virtual post office server 140 to create a postage indicia and Data Matrix barcode for each mail piece associated with the customer order, and then communicate with the image server 130 to retrieve an appropriate image that may be used in assembling the print ready format of the customer order. For example, in one implementation, the label server 125 may create a print image various different formats, including PDF or various bitmap formats, using one or more customer images stored and otherwise managed at the image server 130. Further information describing techniques that may be used to generate the postage indicia and/or Data Matrix barcode are described in U.S. Pat. No. 6,005,945, entitled “System and Method for Dispensing Postage based on Telephonic or Web Milli-Transactions,” issued Dec. 21, 1999, and co-pending U.S. patent application Ser. No. 09/990,605, entitled “Systems and Methods for Detecting Postage Fraud Using a Unique Mail Piece Indicium,” filed Nov. 20, 2001, the disclosures of which are hereby incorporated by reference in their entirety.

The label server 125 may be further configured to provide a mechanism to allow a third-party developer to request postage, rates, and account information via web service calls. As such, third-party developers may integrate postage generation capabilities of the system 100 into proprietary shipping systems, including websites, product fulfillment systems, direct mail systems, or any other system or application that may have a need for postage generation capabilities. In particular, the label server 125 may expose an application program interface for postage and label services, which may be used to develop third-party applications that can communicate with the system using web service calls. For example, in one implementation, the label server 125 may be configured to receive a request via a web service call, wherein the request includes an origin country code or identifier. As such, a system that issued the web service call can specify a particular country for which postage, rates, or other information is requested from the online postage system 100. The label server 125 may then examine the request to determine the country code specified in the request and issue a call to an appropriate virtual post office server 140 that supports the specified country. Further information describing techniques that may be used to integrate third-party applications are described in co-pending U.S. patent application Ser. No. 11/341,273, entitled “Integrated Postage and Shipping Label System,” filed Jan. 26, 2006, the disclosure of which is hereby incorporated by reference in its entirety.

In one implementation, the web server 120 may contain application-specific logic that coordinates communication among the label server 125, the virtual post office servers 140, or other components of the system 100. Furthermore, in one implementation, multiple web servers 120 may be used, with each particular web server 120 providing various different country specific workflows to control components of the system 100.

The web server 120 may be further coupled to the virtual post office server 140, the primary entity for handling transactions in the system 100. The virtual post office server 140 may be configured to generate postage indicia for customer orders and handle secure financial transactions. In addition to customer orders and requests, the transactions handled in the virtual post office server 140 may further include administrative functions, such as adding accounts, processing refunds, deleting accounts, or performing administrative functions, as will be apparent. Furthermore, the virtual post office server 140 may be configured to process requests associated with one or multiple countries on a single server, or to only process requests for a single country, or to process requests in various other ways (e.g., a plurality of logical servers may be used, with each being designated to process requests for a particular national post office).

In one implementation, the virtual post office server 140 may include a cluster of physical servers, each having a cryptographic card 145a installed internally and each having a payment mechanism 145b for handling secure financial transactions. Furthermore, the virtual post office server 140 may be arranged in a redundant, load balanced server array, including anywhere from two to thirty-two servers based on Microsoft Server 2003 that equally share incoming transactional traffic. As a result, if any of the servers associated with the virtual post office server 140 fail or otherwise require removal from service (e.g., if a pending failure has been detected or a software upgrade is required), the remaining servers may automatically pick up the transactional load.

In one implementation, the cryptographic card 145a internally installed at each physical server in the virtual post office server cluster 140 may include an IBM 4764 Cryptographic Coprocessor Card. Within system 100, the cryptographic card 145a may be used as a Postal Cryptographic Coprocessor (PCC), which provides a secure environment for managing indicia generation and customer account updates at the virtual post office server 140. In particular, the cryptographic card 145a may execute customized software configured to perform specific postage operations for the system 100. The cryptographic card 145a may be used limit possible tampering in the system 100, as the PCC environment may be configured to be the only location in the system 100 where register manipulations may occur. The PCC environment may further be configured to perform all server-side encryption and decryption operations.

The encryption and decryption operations performed under the control of the cryptographic card 145a may include, among other things, generating digital signatures and performing data authentication. Generating digital signatures may be necessary to provide security for postage indicia generated in response to a customer order, wherein the digital signature for postage indicia may be based on an Elliptic Curve Cryptography (ECC) algorithm.

The data authentication operations may be necessary to validate authenticity of data stored externally to the PCC environment, wherein the cryptographic card 145a creates a Message Authentication Code (MAC) for key data to be validated. The MAC may be used during various processes to validate that the data has not been altered outside of the PCC environment. For example, various data components may be assembled to create a MAC Master Key, and the MAC Master Key may then be used to create a Data Encryption Standard (DES) MAC for the data being validated. In one implementation, encryption algorithms may be used in the system 100 for a single country, or an encryption algorithm and cryptographic card 145a combination can be implemented according to specifications and security requirements of each national post office supported in the system 100.

As shown in FIG. 1A, the system 100 may include a production data center 160 that includes various database systems 170 that collectively store all data for the customers 105 as well as information relating to all postage and financial transactions. In one implementation, the database systems 170 may be hosted using a plurality of large-scale Microsoft SQL Server 2005 Enterprise database servers, including at least one reporting database server 175a and at least one transaction database server 185a. The transaction database server 185a may be configured to run on a fault tolerant failover cluster, which may ensure that the system 100 continues to operate if one or more of the database servers fail or require other maintenance.

Each of the database servers 175a and 185a may be coupled to a respective database, wherein the reporting database server 175a may be coupled to an online analytical processing (OLAP) database 175b, and wherein the transaction database server 185a may be coupled to an online transaction processing (OLTP) database 185b. Among other things, the databases 175b and 185b may store nationalities for various postal services for which postage is being generated, whereby one combination of the OLAP database 175b and OLTP database 185b can store information for users working with multiple national post offices. Moreover, extending support for a new national post office can easily be implemented by adding additional data fields for a new country. Additionally, in one implementation, the production data center 160 may include a distinct set and/or sub-set of components for handling transactions associated with each national post office supported in the system 100.

The transaction database 185b may also store customer account data, key information, and transaction and activity logs. The reporting database 175b may contain a replica of the transaction database 185b, which may remain synchronized with the transaction database 185b using SQL Server replication. The reporting database 175b may also include tables and indexes that support reporting for administrative and management purposes, and this information may be used to enrich the transactional information replicated from the transaction database 185b. Further, stored procedures and triggers may be used to preserve integrity of the databases 175b and 185b, whereby inconsistent data between tables may be prevented. For example, in one implementation, the stored procedures and triggers may employ distinct “units of work” for a given transaction, where an entire transaction will be aborted and all pending changes rolled back if any part of the transaction fails (e.g., because of a log file failure).

In one implementation, the production data center 160 may interface with one or more secure data systems, including a secure File Transfer Protocol (FTP) server 190a, an electronic mail server 190b, or other systems, as will be apparent. Customers 105 or other users may access the FTP server 190a, the electronic mail server 190b, or other data systems to transmit information to the system 100. For example, in one implementation, a high volume customer 105 may periodically submit an upload file over a secure connection (e.g., on a daily basis), and the upload file may include a plurality of postal transactions. As such, high volume shippers may simply contact the system 100 at the end of a given shipping period to handle all postage transactions rather than having to individually request postage for each transaction. A monitor and control module 165b associated with a job processing system 165 may monitor for received files and process the files upon arrival. Further information describing techniques that may be used to handle multiple postage transactions using a single data file are described in co-pending U.S. patent application Ser. No. 11/165,636, entitled “Tracking Recordation System for Packages,” filed Jun. 23, 2005, the disclosure of which is hereby incorporated by reference in its entirety.

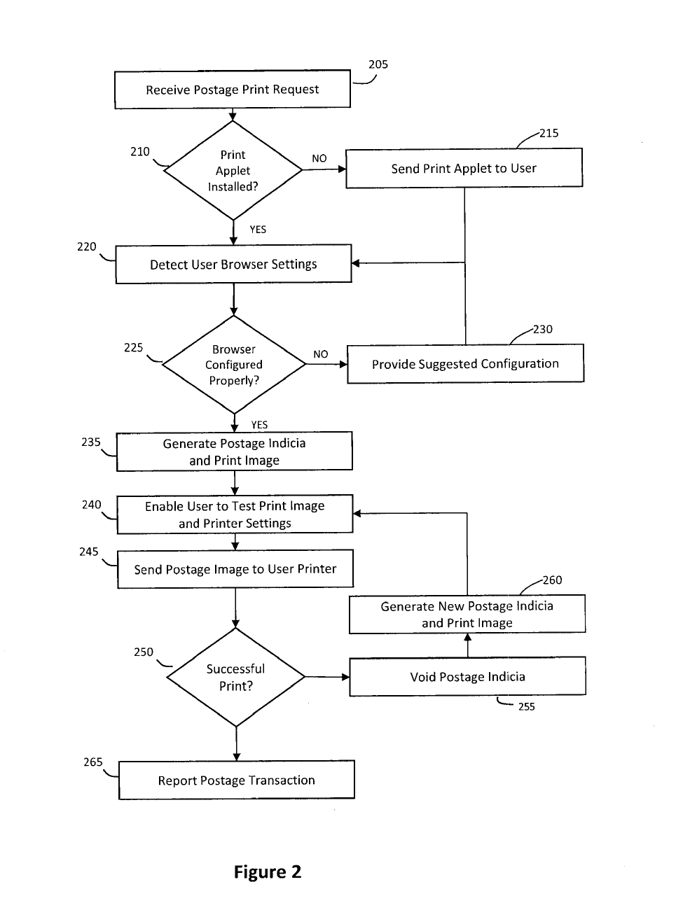

According to one aspect of the invention, FIG. 2 illustrates a block diagram of an exemplary process for silently delivering printable postage to a client device that includes one or more processors, which may be used in connection with the system 100 illustrated in FIG. 1A. In particular, silently delivering printable postage to the user according to the process illustrated in FIG. 2 may remove a user's ability to view, save, and reprint postage at will, while still allowing the user to select a printer for output and adjust settings for the printer. Furthermore, the process illustrated in FIG. 2 may reduce a likelihood of the user fraudulently reprinting postage, while also allowing the user to perform test printings (e.g., using a specimen of the postage) to ensure that a final postage output will print correctly on a target printer.

As illustrated in FIG. 2, an operation 205 may include a user submitting a request for postage and/or label services to the system 100 described above in relation to FIGS. 1A-B. In one implementation, the user may submit the request using one or more web pages provided as a front-end via a web server that includes one or more processors, or the user may submit a request using an integrated third-party application. The request may generally relate to postage for one or more mail pieces, and may further include a country code that specifies a national post office to be used to ship the mail piece. In response to the request, various forms of information may be validated as necessary, including customer account information, destination address, or other information. If the request can be validated, the system may initiate a transaction that includes generating a postage image that can be silently printed at the user's system.

In particular, some degree of control will typically be required at the user's system in order to control the output format of postage being printed. Historically, printing on envelopes has been difficult because different printer models have different configurations with respect to envelope orientation, margins, no-print zones, feed mechanisms, and other configurations. Furthermore, when using a web browser interface, there tends to be considerable variation in the manner in which various different browser versions handle printing. For instances, different browsers may have different levels of support for print layouts, margin sizes, or other printer configurations. Thus, in the context of a web-based postage system, as described above in connection with FIGS. 1A-B, image-based formats such as Portable Document Format (PDF) provide an effective mechanism for controlling print output. Thus, the silent printing process may create printable documents containing fully configured postage images formatted as PDFs.

To prevent users from fraudulently reusing the postage images, the process illustrated in FIG. 2 may be used to send printable postage images directly to the user's printer, bypassing any other applications. However, many commonly used operating systems do not provide native support for PDF documents, meaning that some software must be present on the user's system to translate from the PDF file format to a format that can be provided to a printer. Providing a reader application (e.g., Adobe Acrobat Reader) does not provide an adequate solution because users can easily save and reprint the postage image. Additionally, custom browser plug-ins suffer from drawbacks in that the user must download a client application and the plug-in must be reconfigured for different browser versions.

Thus, the silent printing process illustrated in FIG. 2 may employ a Java applet to handle the silent printing process, whereby a script runs securely and transparently within a browser window. In particular, the Java applet may cause the user's system to render the electronic form of the postage image on a printer (i.e., the Java applet renders the printable postage image to a printer device rather than a display or screen coupled to the user system). In one implementation, the script may be based on jPDFPrint, which provides a Java applet that allows for silent printing of PDF documents. When the postage request received from in operation 205 has been processed, the system may encapsulate a PDF postage image with the jPDFPrint applet to create a seamless silent print experience for the user. Many browsers may require appropriate configurations to execute Java applets, however, such that an operation 210 may include determining whether that the user has downloaded the applet. For instance, the first time that a user engages in the silent printing process, the user may be presented with a window or dialogue box that appears when a download is requested from a site. If the user approves the download or the user's browser is configured to automatically allow execution of scripts, the applet may be delivered to the user in an operation 215. In one implementation, the applet may be delivered to the user's system with the postage image, and the applet may thereafter reside in the user's browser cache until the cache is cleared or the browser otherwise removes the applet. If the user subsequently requests another postage image, the applet may be downloaded to the user's browser.

For subsequent uses of the silent printing process or after the applet has been otherwise delivered to the user, the user's browser settings may be detected in an operation 220. In particular, different web browsers often have different printer settings, and operation 220 may be used to mitigate certain problems with browser configurations that may interfere with the printing process. Thus, if an operation 225 determines that the browser is not properly configured, an operation 230 may provide recommended browser settings to the user and return control to operation 220 to recheck the browser settings. In one implementation, the recommendations may proactively suggest steps that the user may take to properly configure the browser for silent printing (e.g., restoring the browser to standard settings).

If operation 225 determines that the browser is properly configured, indicia for the postage and a printable image may be generated in operation 230. For example, the postage indicia and printable image may be generated using techniques described above and/or in the above-referenced United States Patents and Patent Applications. An operation 240 may then permit the user to test settings for an attached printer and/or the print image. For example, the user may be permitted to preview the postage and create an unlimited number of specimens print-outs to verify the printer settings, wherein the previewed postage may be distinct from the final printable image (i.e., the preview image may be rendered only for purposes of testing the printer and ensuring that the test image appears as desired, but the preview image does not provide usable postage).

Once the user indicates that the printer settings and test image were satisfactory, an operation 245 may deliver the printable image of the postage to the user system, and the image may be transparently and silently translated into a format that can be delivered directly to the user's printer via the applet executing in the user's browser. For example, the image may be stored in the user's computer memory, rather than on the user's disk or browser cache, such that the user cannot access the image for re-printing. In one implementation, the user may be given a predetermined number of opportunities to reprint in the event that the silent printing fails (e.g., one reprint).

An operation 250 may determine whether the print was successful, wherein the postage transaction may be reported and processed in an operation 265 when the print was successful. If the print was not successful, control may be directed to an operation 255, wherein the original print indicia will be automatically voided. In this manner, if the original print indicium is ever used in the mail stream, fraud may be quickly and easily detected when a postal service scan process recognizes the indicia as invalid and/or voided. The postal service and/or online postage provider may then take action to remedy the fraud, such as refusing the mail piece or adding the sender's information to a fraud tracking system. Furthermore, voiding the original indicia in operation 255 ensures that only one valid set of indicia will be generated, wherein duplicates from the first printing may be automatically tracked as having been voided.

Once the original indicia have been voided, new identifiers may be generated for the postage indicia, and control may return to operation 240 wherein the user may test the new print image and then retry the print process in operation 245. When the postage prints successfully, the postage transaction may be reported in operation 265 and the silent printing process may terminate.

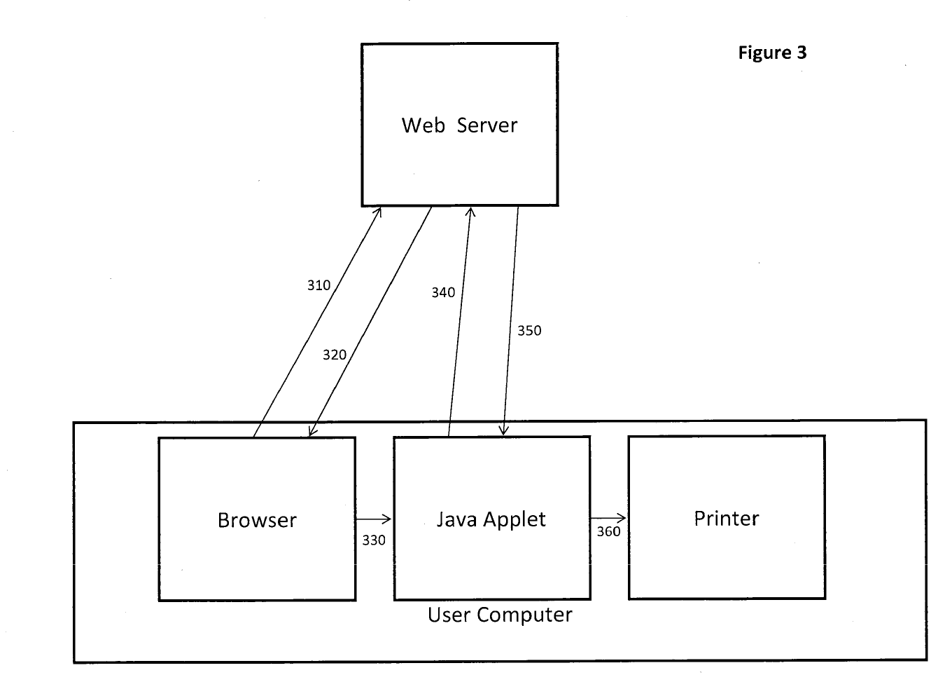

According to one aspect of the invention, FIG. 3 illustrates a block diagram of an exemplary system and workflow for silently printing postage at a user system according to the process illustrated in FIG. 2. In particular, the system may include a user computer that includes one or more processors communicatively coupled to a web server that includes one or more processors providing postage generation services. The user computer may include, among other things, an attached printer and a web browser that can be configured to execute a Java applet. For example, in an operation 310, the browser executing on the user computer may request the applet from the web server, and the browser may then download the applet from the web server in an operation 320. Subsequently, the browser may run the applet on the user computer in an operation 330, wherein the applet may be configured to communicate with the web server in an operation 340 to request a printable postage indicia. Upon validating the request, the printable postage indicia may be received at the user computer via the applet in an operation 350, and the applet may be configured to render the printable postage indicia to the attached printer. Accordingly, the entire process for requesting and printing an image may be handled within the applet, which ensures that the postage indicia is not rendered on a display device coupled to the user computer.

Various embodiments of the invention may provide a scalable technology infrastructure capable of being integrated with various third-party systems to provide secure postage generation services for multiple national post offices.

It should be appreciated that the embodiment relating the multinational postage service can be used independently of the silent printing embodiment and vice versa. Alternatively, the two embodiments may be used together.

Implementations of the invention may be made in hardware, firmware, software, computer program modules, or various combinations thereof. The invention may also be implemented as instructions stored on a machine-readable medium, which may be read and executed using one or more processing devices. In one implementation, the machine-readable medium may include various mechanisms for storing and/or transmitting information in a form that can be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. While firmware, software, routines, computer program modules, or instructions may be described in the above disclosure in terms of specific exemplary aspects and implementations performing certain actions, it will be apparent that such descriptions are merely for the sake of convenience and that such actions in fact result from computer systems, computing devices, processing devices, processors, controllers, or other devices or machines executing the firmware, software, routines, computer program modules, or instructions.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

1. A system for delivering printable postage to a client device, the system comprising at least one processing device configured to:
receive at least one postage request from a client device;
assemble a printable postage image for the postage request, wherein the printable postage image includes a unique postage indicia associated with a national post office; and
send the printable postage image to the client device, wherein the client device is configured to execute a script that automatically delivers the printable postage image to a printer coupled to the client device without displaying the printable postage image to the client device.

2. The system of claim 1, wherein the printable postage image is formatted as a Portable Document Format (PDF) document.

3. The system of claim 1, wherein the script comprises a jPDFPrint printing application.

4. The system of claim 1, wherein the processing device is further configured to:
detect a configuration for a web browser associated with the client device;
ensure that the web browser is properly configured to execute the script; and
provide a suggested configuration for the web browser if the web browser is not properly configured to execute the script.

5. The system of claim 1, wherein the processing device is further configured to:
enable the client device to preview the printable postage image;
enable the client device to test settings of the printer coupled thereto; and
enable the client device to create an unlimited number of specimens of the printable postage image to verify the printer settings.

6. The system of claim 1, wherein the processing device is further configured to enable the client device to reprint the printable postage image a predetermined number of times if the printer fails to properly print the postage image.

7. The system of claim 1, wherein the processing device is further configured to:
void the unique postage indicia if printing the printable postage image fails;
generate a new printable postage image for the postage request, wherein the new printable postage image includes a new unique postage indicia associated with the national post office; and
send the new printable postage image to the client device.

8. A computer-implemented method for delivering printable postage to a client device, the method implemented on a computer system comprising one or more processors configured to execute one or more program modules, the method comprising:
receiving, at electronic storage media accessible to the one or more processors, at least one postage request from a client device;
executing, on the one or more processors of the computer system, one or more computer program modules configured to assemble a printable postage image for the postage request, wherein the printable postage image includes a unique postage indicia associated with a national post office; and
executing, on the one or more processors of the computer system, one or more computer program modules configured to send the printable postage image to the client device, wherein the client device is configured to execute a script that automatically delivers the printable postage image to a printer coupled to the client device without displaying the printable postage image on the client device.

9. The computer-implemented method of claim 8, wherein the printable postage image is formatted as a Portable Document Format (PDF) document.

10. The computer-implemented method of claim 8, wherein the script comprises a jPDFPrint printing application.

11. The computer-implemented method of claim 8, further comprising:
executing, on the one or more processors of the computer system, one or more computer program modules configured to detect a configuration for a web browser associated with the client device;
executing, on the one or more processors of the computer system, one or more computer program modules configured to ensure that the web browser is properly configured to execute the script; and
executing, on the one or more processors of the computer system, one or more computer program modules configured to provide a suggested configuration for the web browser if the web browser is not properly configured to execute the script.

12. The computer-implemented method of claim 8, further comprising:
executing, on the one or more processors of the computer system, one or more computer program modules configured to enable the client device to preview the printable postage image;
executing, on the one or more processors of the computer system, one or more computer program modules configured to enable the client device to test settings of the printer coupled thereto; and
executing, on the one or more processors of the computer system, one or more computer program modules configured to enable the client device to create an unlimited number of specimens of the printable postage image to verify the printer settings.

13. The computer-implemented method of claim 8, further comprising executing, on the one or more processors of the computer system, one or more computer program modules configured to enable the client device to reprint the printable postage image a predetermined number of times if the printer fails to properly print the postage image.

14. The computer-implemented method of claim 8, further comprising:
executing, on the one or more processors of the computer system, one or more computer program modules configured to void the unique postage indicia if printing the printable postage image fails;
executing, on the one or more processors of the computer system, one or more computer program modules configured to generate a new printable postage image for the postage request, wherein the new printable postage image includes a new unique postage indicia associated with the national post office; and
executing, on the one or more processors of the computer system, one or more computer program modules configured to send the new printable postage image to the client device.

15-35. (canceled)

36. A computer-readable storage medium containing an executable script to silently print postage images, wherein executing the executable script on a computer device causes the computer device to:
receive a printable postage image;
cause a printer to print the printable postage image; and
prevent displaying the printable postage image on a display associated with the computer device.

37. The computer-readable storage medium of claim 36, wherein executing the executable script on the computer device further causes the computer device to display an unusable preview version of the printable postage image.

38. The computer-readable storage medium of claim 37, wherein executing the executable script on the computer device further causes the computer device to print the unusable preview version of the printable postage image to test settings of the printer.

39. The computer-readable storage medium of claim 37, wherein executing the executable script on the computer device enables the computer device to create and print an unlimited number of specimens of the unusable preview version of the printable postage image to verify settings of the printer.

40. The computer-readable storage medium of claim 36, wherein executing the executable script on the computer device enables the computer device to reprint the printable postage image a predetermined number of times if the printer fails to properly print the postage image.

41. The computer-readable storage medium of claim 36, executing the executable script on the computer device enables the computer device to:
request voiding the printable postage image if the printer fails to properly print the printable postage image;
receive a new printable postage image;
cause the printer to print the new printable postage image; and
prevent displaying the new printable postage image on the display.
